(19) United States
(12) Patent Application Publication
(10) Pub. No.: US 2013/0110740 A1
(43) Pub. Date: May 2, 2013

(54) ONLINE SALES TOOL

(71) Applicants: Scott Timothy Leland, Milwaukee, WI (US); Tapan Shah, Bellevue, WA (US)

(72) Inventors: Scott Timothy Leland, Milwaukee, WI (US); Tapan Shah, Bellevue, WA (US)

(21) Appl. No.: 13/284,306

(22) Filed: Oct. 28, 2011

(51) Int. Cl. G06Q 10/06

(52) U.S. Cl. 705/348

(57) ABSTRACT

An online system generates, stores and permits sharing of a client's organizational information and how an individual or an individual's company may fit within the client's organizational landscape. The online system may generate a visual sales plan referred to as a Player Map. The Player Map (PM) may show the unofficial roles that people fill in an organization as well as show what bridges need to be built and how to make the best use of available resources. The online system, which may be referred to as Player Map X-ray (PMX) of the present invention may operate in a cloud environment, allowing users to access the system wherever they have internet access and also allowing team members to access shared Player Maps.

### BACKGROUND OF THE INVENTION

The present invention relates to an online sales tool and, more particularly, to a dynamic, visual sales plan that illustrates a client's political and organizational landscape and which shows the user how they and their company fit into that environment.

Organizational structures are changing. The hierarchal organizational structure is giving way to flat and even virtual environments. As the organizational structure changes, a sales force needs to change the manner in which they position themselves to make deals. There is a need to know the unofficial roles that people fill in an organization as well as knowing what bridges need to be built and how to make the best use of available resources. A traditional organization chart doesn't provide much help to achieve these goals.

As can be seen, there is a need for a visual sales plan that can illustrate a client's landscape and how their company fits into such an environment.

### SUMMARY OF THE INVENTION

In one aspect of the present invention, a method for generating, storing and sharing a visual sales plan comprises accessing an online site adapted to permit a user to create a new visual sales plan or edit an existing visual sales plan; entering one or more players into the visual sales plan on the online site; coding the visual sales plan to provide roles and responsibilities as well as bridges between players or between players and team members; saving the visual sales plan; and selecting other users to have access to the visual sales plan.

In another aspect of the present invention, an online sales tool comprises an online module for enter information about players and team members; an online module for coding roles and relationships of the players and team members; an online module for coding bridges among players and between players and team members; and an online module for storing and sharing the online sales tool among selected users.

In a further aspect of the present invention, software having program code stored on a computer readable media comprises program code adapted to permit a user to enter information about players and team members; program code adapted to permit a user to code roles and relationships of the players and team members; program code adapted to permit a user to code bridges among players and between players and team members; and program code adapted to generate, store and share a Player Map generated from data entered into the software.

These and other features, aspects and advantages of the present invention will become better understood with reference to the following drawings, description and claims.

### BRIEF DESCRIPTION OF THE DRAWINGS

FIG. 1 is a flow chart describing a method in which a user may use a player map according to an exemplary embodiment of the present invention;

FIG. 2 is a chart showing the integration of components that embody the player map system of the present invention;

FIG. 3 is a detailed flow chart describing a detailed method in which a user may use a player map according to an exemplary embodiment of the present invention; and

FIG. 4 is a schematic representation of a player map according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an online system for the generation, storage and sharing of a client's organizational information and how an individual or an individual's company may fit within the client's organizational landscape. The online system may generate a visual sales plan referred to as a Player Map. The Player Map (PM) may show the unofficial roles that people fill in an organization as well as show what bridges need to be built and how to make the best use of available resources. The online system, which may be referred to as Player Map X-ray (PMX) of the present invention may operate in a cloud environment, allowing users to access the system wherever they have internet access and also allowing team members to access shared Player Maps.

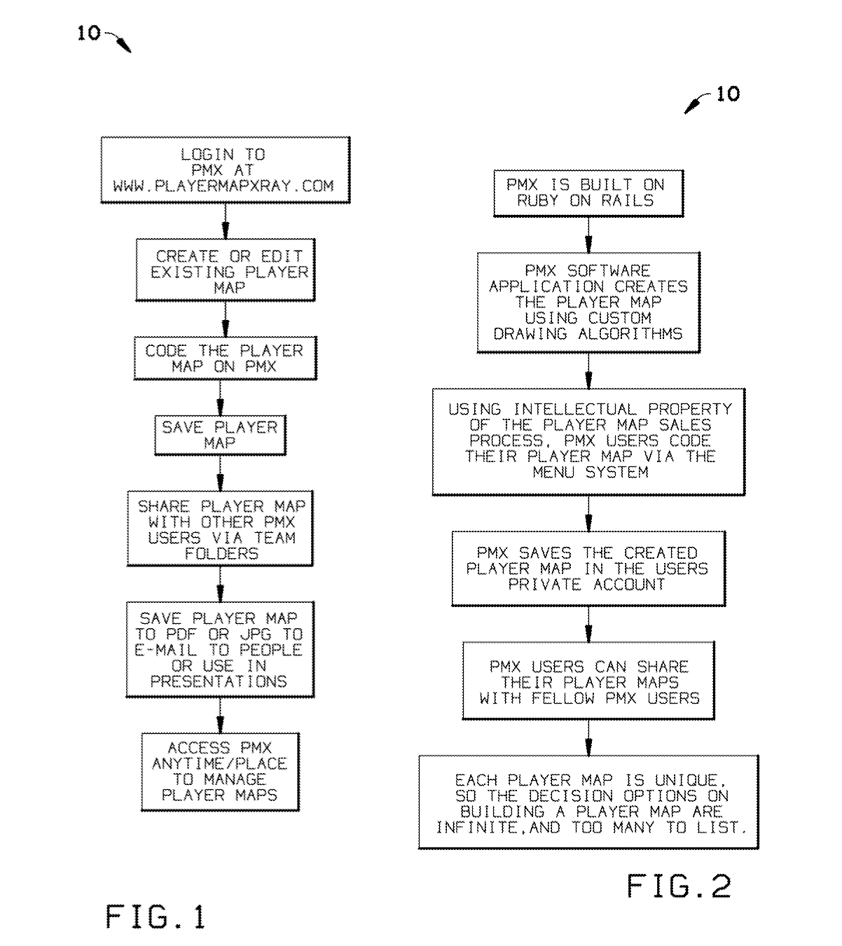

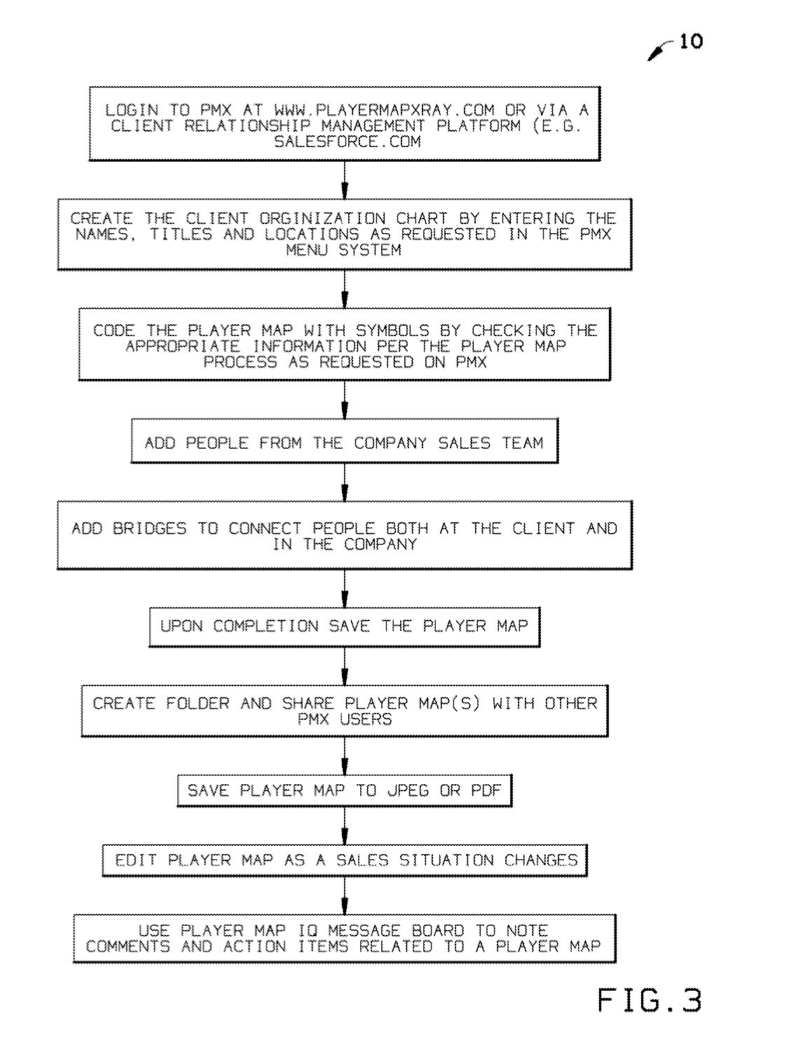

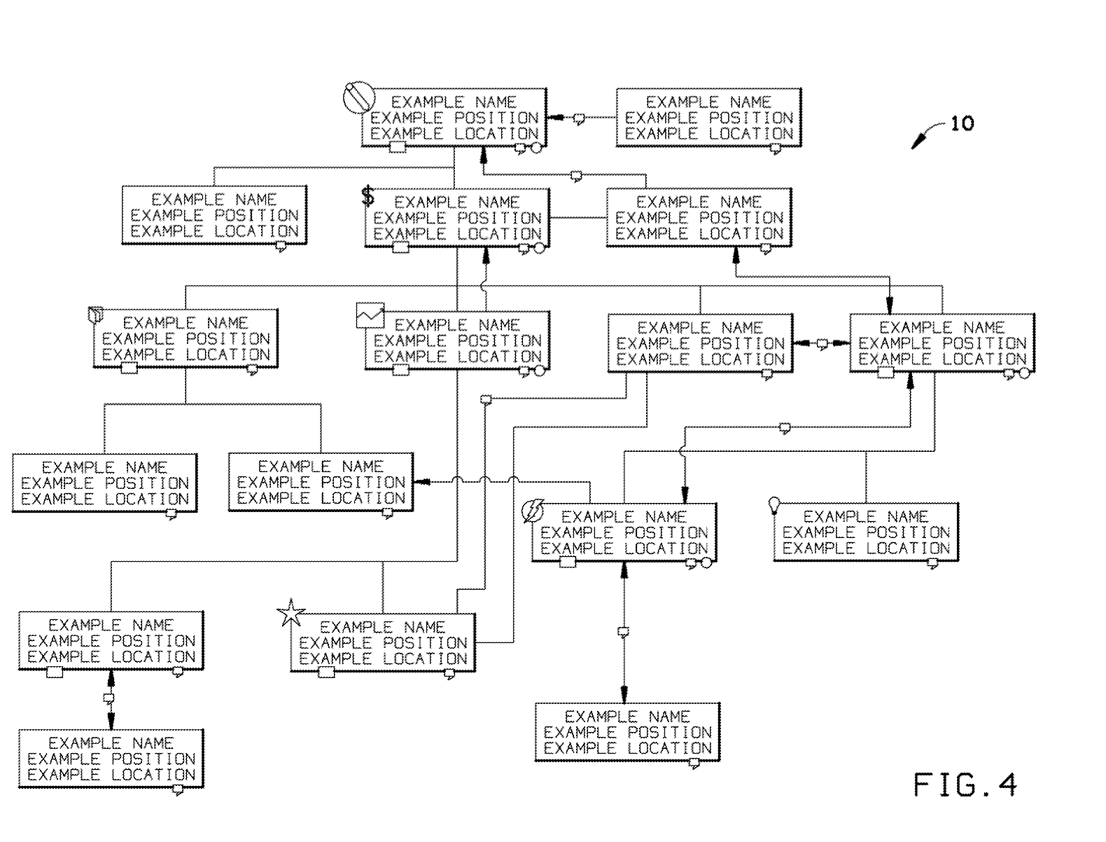

Referring to FIGS. 1 through 3, a user may log into PMX at a designated website or via a client relationship management platform, such as Salesforce.com®. The PMX site may be constructed in various manners known in the art. For example, PMX may be built on ruby on rails. Once logged in, a user may create a new PM or may edit an existing PM. The user may code the PM with appropriate symbols. These symbols may be proprietary symbols related to the PM sales process. The user may add people from their own company, such as sales personnel. In addition, the user may add people from the client company and add bridges to connect people. Upon completion of the creation or editing of the PM, the user may save the data. Details on the subject mattered entered into the PM is discussed below with reference to FIG. 4.

The PMX software may create the PM using drawing algorithms. The drawing algorithms may create a single page PM that defines the players, team and their various roles and connections.

The PMX software may permit a user to share the PM with certain team members. The PM owner may permit certain team members the ability to add to the PM, resulting in a collaborated effort to combine organizational knowledge. The PM may be edited as the organization changes, or an new players are determined.

The PMX software may operate on a server computer to permit users internet access to run the software and store their data within the server computer. The PMX software may reside as a cloud-based application. In some embodiments, a smart phone application may provide access to the PMX software and permit access to create and edit Player Maps. The PMX software may include program code, stored on computer readable media, that permits a processor to execute commands to carry out the various functions described herewithin.

Referring now to FIG. 4, a sample PM is shown. The PM may include color-coded boxes showing, for example, the name, position, and location of both players (the members of the target organization) and team members (for example, the user and other personnel within the user's company). These boxes may include one or more colored or shaped icons. The icons may indicate that the shown person is a champion (someone working to help the user win), is a source (provides the user with confidential/inside project information), is a solution (an expert chartered with overseeing/designing the solution), is a business (primarily interested in the business impact of the project), has pen power (person who must ultimately endorse/sign-off on the project), has funds (administers funds or secures the funding for the project), is a contract person (responsible for finalizing contract terms for the project), or a competitor (someone backing a competitor and hindering the user's ability to win). The PM may also include links between the boxes, the links may indicate, for example, that a bridge (professional or personal relationship) exists between persons or that a bridge is required to exist between persons. Notes may be attached to the PM, so that clicking on the notes button could pull-up user entered notes. Other social media links may also be provided on the PM, such as LinkedIn, for example. A color-coded power meter may be added to the PM to show a hierarchy of power between players on the PM.

The PMX software may include a plurality of screens to help enter, maintain and control data. For example, a Home screen may offer the user the ability to create a new folder or PM or to select from an existing database of folders and PMs. Once folders and PMs are shown, the user may have the ability to edit, share or delete PMs. The PMs may be moved or copied to other folders, printed, or downloaded as, for example, JPG or PDF files.

The PMX software may include a PMX IQ feature which allows a user to leave short comments regarding a PM for a team to review and act on. The PMX software may further include an option of automatically sending all associated team members an alert email to advise whenever a PM is changed. This may help improve team collaboration.

While only certain information may be displayed on a PM, there may be additional information associated with each player or team member included in a PM. For example, the PMX software may include a module to add a person to a PM. This module may include mechanisms to assign reporting relationships, title, location, power, roles, and bridges. This module may also allow links to social media sites as well as free-form notes. Bridges may also contain notes, so that users may understand if the bridge is personal or professional in nature, for example.

Users may use PMX to generate, store and share PMs and to create a one page visual sales plan unique to the PM sales process, helping users to visually map their strategic sales plan, resulting in an increased win rate.

It should be understood, of course, that the foregoing relates to exemplary embodiments of the invention and that modifications may be made without departing from the spirit and scope of the invention as set forth in the following claims.

What is claimed is:

1. A method for generating, storing and sharing a visual sales plan, comprising:
accessing an online site adapted to permit a user to create a new visual sales plan or edit an existing visual sales plan;
entering one or more players into the visual sales plan on the online site;
coding the visual sales plan to provide roles and responsibilities as well as bridges between players or between players and team members;
saving the visual sales plan; and
selecting other users to have access to the visual sales plan.

2. The method of claim 1, further comprising entering one or more team members into the visual sales plan by entering information about the one or more team members into the online site.

3. The method of claim 1, wherein the visual sales plan is generated and stored in a cloud-based application.

4. An online sales tool comprising:
an online module for enter information about players and team members;
an online module for coding roles and relationships of the players and team members;
an online module for coding bridges among players and between players and team members; and
an online module for storing and sharing the online sales tool among selected users.

5. The online sales tool of claim 4, further comprising an online module for generating and printing a Player Map showing roles, responsibilities and relationships for the players and the team members.

6. The online sales tool of claim 5, further comprising an online messaging module for noting comments and action items related to the Player Map.

7. The online sales tool of claim 5, further comprising an online module for editing a Player Map as additional information about players is determined or as an organization changes.

8. Software having program code stored on a computer readable media, the software comprising:
program code adapted to permit a user to enter information about players and team members;
program code adapted to permit a user to code roles and relationships of the players and team members;
program code adapted to permit a user to code bridges among players and between players and team members; and
program code adapted to generate, store and share a Player Map generated from data entered into the software.

9. The software of claim 8, further comprising program code for printing the Player Map as a single page, showing roles, responsibilities and relationships for the players and the team members.

10. The software of claim 8, further comprising program code for noting comments and action items related to the Player Map.
